(19) United States
(12) Patent Application Publication
(10) Pub. No.: US 2009/0283690 A1
(43) Pub. Date: Nov. 19, 2009

(54) SYSTEM AND METHODS FOR DETECTING CONCEALED NUCLEAR MATERIAL IN CARGO

(76) Inventor: Joseph BENDAHAN, San Jose, CA (US)

Correspondence Address: General Electric Company;GE Global Patent Operation, PO Box 861, 2 Corporate Drive, Suite 648, Shelton, CT, 06484, US

(21) Appl. No.: 12/201,237

(22) Filed: Aug. 29, 2008

Related U.S. Application Data
(60) Provisional application No. 61/052,881, filed on May 13, 2008.

(51) Int. Cl. G01T 3/00; G01T 1/00

(52) U.S. Cl. 250/390.01; 376/159

(57) ABSTRACT

A cargo inspection system and active inspection methods for operating the same to confirm or clear a presence of explosives and/or nuclear materials in cargo. The active inspection methods use high-energy photons and/or neutrons to induce fission, and measure prompt neutrons, delayed neutrons, and delayed gamma-rays. Additionally, if one or more suspect objects are identified within the cargo with a preceding radiographic or computed tomography scan, a microprocessor calculates a position that produces optimal active inspection signals. The cargo or one of a primary radiation source, a secondary radiation source, or one or more radiation detectors are moved to this calculated position before fission occurs.

### CROSS-REFERENCE TO RELATED APPLICATIONS

This application claims the benefit under 35 U.S.C. 119(e) of the filing date of prior-filed U.S. provisional patent application Ser. No. 61/052,881, filed on 13 May 2008, which is hereby incorporated by reference in its entirety.

### BACKGROUND

1. Field of the Invention

The field of the invention relates to cargo inspection systems generally, and, more particularly, to certain new and useful advances in computerized cargo inspection systems employing active (fission) inspection techniques to detect nuclear materials, of which the following is a specification, reference being had to the drawings accompanying and forming a part of the same.

2. Discussion of Related Art

To combat terrorism, cargo transported in sea-land cargo containers, air cargo containers, and the like is inspected for the presence of nuclear materials. Typically, the cargo inspections inject neutrons or high-energy photons into the cargo to induce fission from which the presence of nuclear materials is inferred.

Active inspection techniques measure one of delayed radiation, differential die-away, or prompt neutrons. Prompt neutrons are immediately emitted when fission occurs, as opposed to a delayed low-energy neutrons and gamma rays, which are emitted by the fission products anywhere from milliseconds to seconds after the fission event. The differential die-away technique pulses neutrons into the cargo and monitors perturbations (if any) in the die-away characteristics of the normal neutron fluence rate that occur between neutron pulses. Another type of active inspection technique measures the number of prompt neutrons that fission produces.

These known examples of active inspection techniques have drawbacks. For example, when a typical cargo inspection uses high-energy neutrons or high-energy photons, the interference caused by activation of benign materials in the cargo makes it difficult to accurately measure delayed gamma rays. As another example, it is difficult to accurately measure delayed neutrons when the cargo contains, or is bounded by, organic materials. Moreover, if a nuclear material is buried too deep within the cargo, fission may not occur, because the injected neutrons or high-energy photons will be attenuated before they reach the nuclear material. On the other hand, if fission does occur, the thickness of the cargo, and/or the presence of heavy organic materials within the cargo, may severely or completely attenuate the prompt neutrons, delayed neutrons, and delayed gamma-rays that the fission event creates.

Neutrons suitable for producing fission can be generated via one of several known reactions. Examples include photon-to-neutron conversion reactions, d-T (the “Deuteron-Tritium reaction”), d-D (the “Deuteron-Deuterium reaction”), p-Li (the “Proton-Lithium reaction)” and so forth. The d-T reaction produces high-energy neutrons (>14 MeV). On the other hand, the d-D reaction can produce either medium-energy neutrons or high-energy neutrons, depending on the dueterons' incident energy.

Large cargo containers are typically inspected using high-energy d-T neutrons. Due to their high-energies, the d-T neutrons penetrate more deeply than d-D neutrons. Additionally, for a given beam energy, d-T neutrons are more prolific than d-D neutrons. Disadvantageously, the d-T neutrons create activation. For example, background interference occurs through the ¹⁶O(n,p)¹⁶N reaction that produces 6.13 MeV and 7.1 MeV gamma rays from the β decay of ¹⁶N with a 7.1 second lifetime, which is similar to the delayed radiation characteristics. Accordingly, it is difficult to measure delayed gamma rays, when d-T neutrons are used.

It is also possible to employ mid-high energy d-D neutrons (<10.2 MeV) to allow for high penetration while avoiding the ¹⁶O activation. However, it still produces activations with other elements, for example with the ¹⁹F(n,α) ¹⁶N reaction, which produces gamma rays having similar characteristics of the gamma rays produced in the ¹⁶O reaction. Disadvantageously, large and expensive accelerators are required to produce mid-high energy d-D neutrons.

Low-energy d-D neutrons avoid activations generally and permit measurement of delayed gamma rays (which are more prolific than delayed neutrons). Disadvantageously, the yield of low-energy d-D neutrons is low compared with the yield of mid-high energy d-D neutrons. Additionally, low-energy d-D neutrons do not penetrate as deeply as high-energy d-T neutrons. Accordingly, traditional methods of implementing the low-energy d-D reaction are not suited for inspecting most cargos, including air cargo, for the presence of a nuclear material.

For at least these reasons, there exists in the art a long-felt need for a cargo inspection system and/or improved active inspection techniques that accurately and reliably detect nuclear materials within cargo.

### SUMMARY

These and/or other disadvantages are addressed, and/or overcome, by embodiments of the claimed invention.

In a first embodiment, a cargo inspection system has a primary radiation source configured for radiography or computed tomography, and for photofission. Radiography produces a conventional two-dimensional x-ray image. Computed tomography produces a three-dimensional x-ray image and/or density data about materials comprising the cargo. The cargo inspection system is further configured to confirm or clear a suspected presence of a nuclear material in the cargo by inducing fission with a high-energy photon source and by measuring prompt and delayed neutrons and gamma rays (if any) that result from the photofission. The cargo inspection system is also configured to move the cargo to a position calculated by a microprocessor to produce optimal active inspection signals. This embodiment lowers the claimed operating costs; reduces false alarm rates; and enables simultaneous detection of conventional explosives and nuclear materials.

In a second embodiment, a cargo inspection system has a primary radiation source configured for radiography or computed tomography, and a second radiation source configured to generate neutrons, which may be pulsed. The generated neutrons are either d-D, d-T, p-Li or other neutron-producing reaction.

In a third embodiment, high-energy photons impinge on a neutron producing material placed between the primary radiation source and the cargo. This mixed photon-neutron source is used to irradiate the cargo.

In each of the second and third embodiments, the cargo inspection system is configured to confirm or clear a suspected presence of a nuclear material in cargo by measuring differential die-away and/or prompt neutrons, delayed neutrons, and delayed gamma rays that result from fission (if any). Additionally, in each of the second and third embodiments, the cargo inspection system is configured to move the cargo, before active inspection is performed, to a position calculated to produce optimal active inspection signals.

Methods for operating various embodiments of a cargo inspection system are also provided.

Advantageously, it has been discovered that use of low-energy d-D neutrons in combination with optimal positioning of the cargo, and/or optimal positioning of other elements of the cargo inspection system, permits accurate measurement of delayed radiation and differential die-away, but with gamma-ray signatures and/or neutron signatures that are improved relative to prior implementations of these techniques. These advantages occur, in part, because low-energy d-D neutrons can be used, which significantly reduces the interference caused by activation. Additionally, although the low-energy d-D neutrons have limited penetrating abilities, the cargo, and/or other elements of the cargo inspection system, is/are moved to a position calculated to produce optimal active inspection signals. Therefore, the low-energy d-D neutrons need only to penetrate at most to approximately the cargo's center, as will be explained below.

Advantageously, correlation between the measured neutron signals and the measured gamma-ray signals, and between delayed signals and differential signals, provides a more robust method for confirming, or clearing, a suspected presence of a nuclear material in a cargo container. Moreover, the inventive integration of radiographic or tomographic systems and methods with specific active inspection techniques judiciously balances throughput, detection, and false-alarm rate considerations. Additionally, since the radiographic or tomographic systems complement the specific active inspection techniques, they can be applied to most organic cargoes, applied to most inorganic cargoes, and adapted to detect a variety of types of nuclear materials.

Embodiments of the claimed invention are described below with reference to operation of a system for inspecting cargo, whether enclosed by a container or not. The cargo may be any type of cargo. In one embodiment, the cargo is air cargo. Any type of cargo container may be used, but in one embodiment, the container is an air cargo container. Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 is a side-view of an embodiment of a cargo inspection system;

FIG. 2 is a top view of the embodiment of the cargo inspection system of FIG. 1 showing an exemplary arrangement of neutron detector and gamma-ray detectors, as well as a radiation source;

FIG. 3 is a schematic of components that comprise the cargo inspection system of FIG. 1;

FIG. 4 is a flowchart of an embodiment of a method of actively inspecting a cargo using fission; and

FIG. 5 is a flowchart of an embodiment of another method of actively inspecting a cargo using fission.

Like reference characters designate identical or corresponding components and units throughout the several views, which are not to scale unless otherwise indicated.

### DETAILED DESCRIPTION

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

As used herein, the term “nuclear material” includes, but is not limited to, plutonium, uranium-233, uranium-235, uranium enriched in the uranium-233 or uranium-235 isotopes, as well as, any other materials that may be deemed “special nuclear materials,” or “source materials,” by the United States Atomic Energy Act of 1954. In particular, the term “nuclear material” includes a fissionable material.

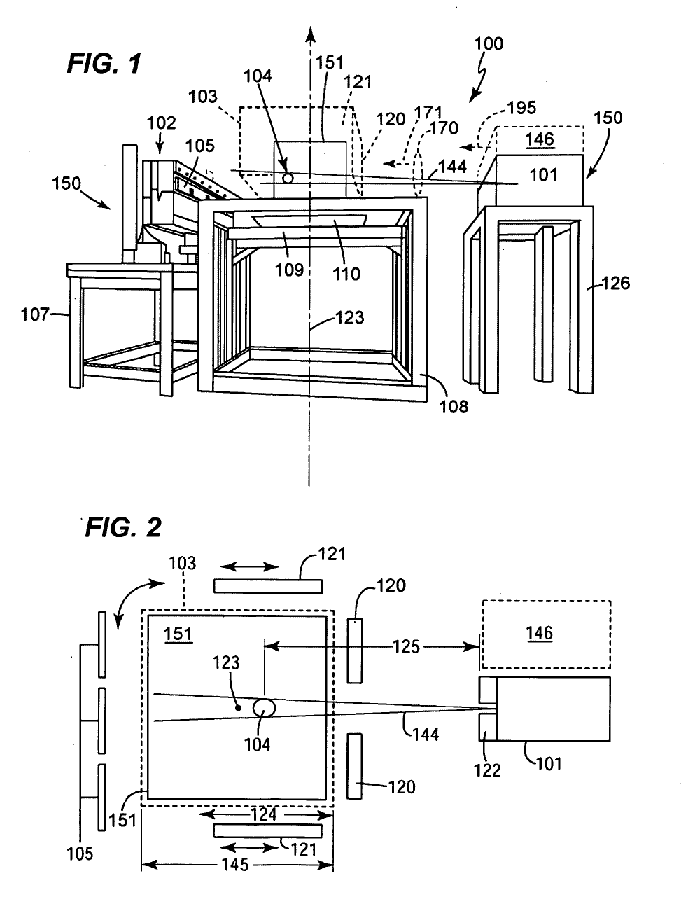

FIGS. 1, 2, and 3 depict an exemplary cargo inspection system 100, configured in accordance with the principles of the claimed invention. FIG. 1 is a side-view of the cargo inspection system 100. FIG. 2 is a top view of the cargo inspection system 100 of FIG. 1, further illustrating an exemplary arrangement of detectors 120, 121. In one embodiment, the one or more detectors 120 are configured to detect prompt neutrons and delayed neutrons, and the one or more detectors 121 are configured to detect delayed gamma-rays.

In another embodiment, each of the one or more detectors 120, 121 is configured to detect prompt neutrons, delayed neutrons, and delayed gamma-rays. In FIGS. 1, 2, and 3, components of a first embodiment are drawn with solid lines, and components of alternate embodiments are drawn in dashed lines.

In contrast to embodiments of the claimed invention, in which the primary radiation source 101 operates at an energy of about 10 MeV or less, prior cargo inspection systems that scan large bulk cargoes, such as those enclosed in sea-land containers, typically generate x-rays having energies around 15 MeV. The higher energies are necessary because large bulk cargoes sometimes contain high-density materials. More importantly, these higher energies are necessary because the high-energy photon radiation has to penetrate a distance of up to about 2.5 m, and because the photon detectors are placed at large distances from the source of radiation. Moreover, due to their size and weight, vertically moving and/or rotating these sea cargoes is too costly and time-consuming to be practical.

On the other hand, referring to FIGS. 1 and 2, embodiments of the claimed cargo inspection system 100 are advantageously configured to rotate cargo 151, such as, but not limited to, air cargo, so that a maximum distance that high-energy photons (or in another embodiment described below, low-energy d-D neutrons) have to penetrate is about half the shortest depth of the cargo 151, typically less than 80 cm. Moreover, the lower average density of air cargo and the closer distance of the detectors 120, 121 to the primary radiation source 101 (and/or to the secondary radiation source 146) permit using lower energy photons (and/or neutrons) than prior cargo inspection systems (i.e., about 10 MeV or less). Consequently, the relatively inexpensive X-ray source employed for radiographic scans or tomographic scans suffices for most air cargoes and suspect object depths.

The high-energy photons generated by the primary radiation source 101 may not penetrate some high-density inorganic cargoes or some high-density nuclear shielding materials. In such cases, neutron active inspection is more suitable. For example, in a neutron-induced fission embodiment, the inspection system 100 includes the primary radiation source 101 and a secondary radiation source 146. The secondary radiation source 146 is configured to produce neutrons 195 that impinge the cargo 151. Depending on the embodiment, the neutrons 195 are one of d-D neutrons, d-T neutrons, or any other type of neutrons that will induce fission. Thus in one embodiment, the secondary radiation source 146 is a d-D neutron source configured to produce low-energy (about, and including, 3 MeV and below) d-D neutrons. For such low energy d-D neutrons, the optimal active inspection signals 160 outputted by one or more of the detectors 120, 121 are produced by detecting delayed gamma-rays, delayed neutrons, and/or prompt neutrons. An advantage of using the low energy d-D neutrons is that the production of delayed gamma rays with common materials is small, resulting in a very low false alarm rate when employing a gamma-ray detection technique.

For example, referring still to FIGS. 1, 2, and 3, a suspect object 104 is located on a side of an axis 123 that is furthest from the radiation source 101. In an embodiment, the axis 23 is a central axis of the cargo 151. If the secondary radiation source 146 is a d-D neutron source, as described below, with a maximum penetration depth 124 (FIG. 2) less than a total depth 145 of the cargo 151, rotating the cargo 151 to the position shown in FIG. 2, will dispose the suspect object 104 at a position 125 from the radiation source 101. The position 125 is calculated by the microprocessor 128 to optimize active inspection signals 160. In FIG. 2, the platform 110 of FIG. 1 has been rotated 180 degrees to position the suspect object 104 on an opposite side of the axis 123—the opposite side being closest to the secondary radiation source 146.

In one embodiment, the position 125 is in most cases within the maximum penetration depth 124 of low-energy d-D neutrons. For example, it is not uncommon for a low-energy d-D neutron beam to have a maximum penetration depth 124 (FIG. 2) of more than 0.8 m. Accordingly, until now, it was not practical to scan cargo 151, especially a cargo 151 having a depth of about 1.6 m, using low-energy d-D neutron beams.

Referring to FIGS. 1, 2, and 3, components of an embodiment of the cargo inspection system 100 include at least one or more detectors 105 and the primary radiation source 101. Each detector 105 is positioned opposite the primary radiation source 101, such that the cargo 151 can be rotatably positioned between the radiation source 101 and the detectors 105. In an embodiment where the primary radiation source 101 is an x-ray source, each detector 105 is configured to measure an intensity of the primary beam 144 of radiation after the primary beam 144 of radiation traverses the cargo 151.

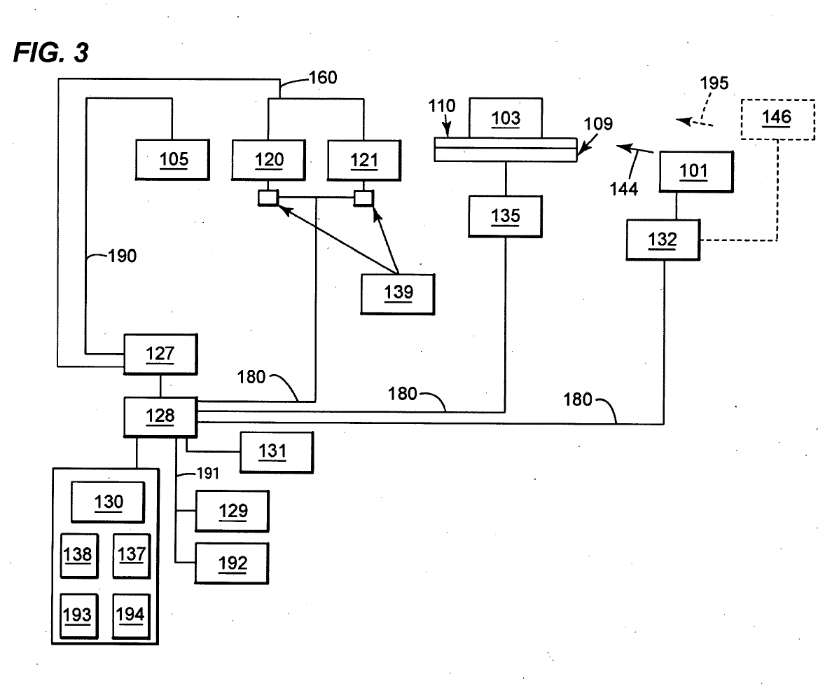

Other components of an embodiment of the cargo inspection system 100 include a first support 107, a second support 108, and a third support 126. As shown in FIG. 1, a detector assembly 102, which supports the one or more detectors 105, rests on the first support 107. The frame 109 is coupled with the second support 108. A movable platform 110 is coupled with the frame 109. As shown in FIG. 3, one or more actuators 135 are coupled with each of the frame 109 and the platform 110, which is configured to support (i.e., to hold) the cargo 151. In one embodiment, the platform 110 is rotatably coupled with the frame 109.

The frame 109 is movable upward and downwards along the axis 123, which passes vertically through a center of the platform 110. Because the platform 110 is coupled with the frame 109, the platform 110 moves upwards and downwards simultaneously with the frame 109. The platform 110 may rotate clockwise or counterclockwise about the axis 123. As shown in FIG. 1, the platform 110 forms a surface for supporting the cargo 151.

In a further embodiment, the frame 109 is stationary. One or more of the primary radiation source 101, the detector(s) 105, the detectors 120, 121, and the secondary radiation source 146 are mounted to a movable platform (not shown). In this embodiment, the platform 110 still rotates and the scanning is performed by vertically moving the one or more of the primary radiation source 101, the detector(s) 105, the detectors 120, 121, and the secondary radiation source 146 while maintaining the cargo 151 at a fixed height. Alternatively, the both platform 110 and frame 109 are stationary. In this embodiment, the one or more of the primary radiation source 101, the detector(s) 105, the detectors 120, 121, and the secondary radiation source 146 are mounted to a movable platform that rotates and/or moves vertically. In one embodiment, the term “vertical” means “parallel to the axis 123.”

Referring again to FIGS. 1, 2, and 3, in one embodiment, the cargo inspection system 100 is configured to confirm or clear a suspected presence of a nuclear material in cargo using an active inspection technique, and includes a scanner 150 having a primary radiation source 101, a detector 105, and/or the detectors 120, 121. Depending on the embodiment, the scanner 150 may be (a) a radiographic scanner or (b) a tomographic scanner (e.g., a Computed Tomography “CT” scanner). The cargo inspection system 100 may also be configured to confirm or clear a suspected presence of a conventional explosive in the cargo 151.

The scanner 150 can be used to pre-inspect a cargo 151, whether enclosed by a cargo container 103 or not, for the presence of one or more suspect objects 104. Suspect objects 104 are multi-dimensional portions of the cargo 151 that have a threat probability that exceeds a predetermined threshold value. In one embodiment, the suspect object(s) 104 are identified in a radiographic inspection of the cargo 151. In another embodiment, the suspect object(s) 104 are identified, and/or further inspected, in a high-resolution tomographic pre-inspection of the cargo 151. This threat probability is calculated by a microprocessor 128, based on, among other things, data about the cargo 151 that results from operation of the scanner 150. That said, pre-inspection of the cargo 151 is not necessary in an embodiment of the claimed cargo inspection system 100 that is configured to detect both conventional explosives and nuclear materials in cargo simultaneously or near-simultaneously. In such embodiments, the primary radiation source 101 emits a high-energy beam of x-ray radiation 144 (e.g., photons). A collimator 122 positioned between the detector 105 and the primary radiation source 101 is used to collimate the high-energy beam of x-ray radiation. As used herein, the term “high energy beam of x-ray radiation” means photons of having energies sufficient to generate fission in a nuclear material (if any) contained in the cargo 151. After the high-energy beam of radiation 144 is emitted, the microprocessor 128 processes measurements of delayed radiation, in the form of signals outputted by the detectors 120, 121, to confirm or clear a suspected presence of nuclear material in the cargo 151. Simultaneously, or near simultaneously, the microprocessor 128 also processes signals 190 outputted by the detector 105 to confirm or clear a suspected presence of a conventional explosive in the cargo 151.

In one embodiment, the primary radiation source 101 operates at about 10 MeV or less to induce photofission in nuclear materials (if any) in the cargo 151. Due to the low activation associated with photofission induced at this energy level, both delayed neutron and delayed gamma-ray measurements can be performed.

In an alternative embodiment, a photon-to-neutron conversion material 170 is positioned between the primary high-energy photon source 101 and the detector 150. In particular, the photon-to-neutron conversion material 170 is positioned between the primary radiation source 101 and the cargo 151. The photon-to-neutron conversion material 170 converts some of the photons produced by the primary radiation source 101 into neutrons 171. The mixed high-energy photons and neutrons 171 produced by the photon-to-neutron conversion material 170 impinge the cargo 151.

In another embodiment, a secondary radiation source 146 is used in combination with the primary radiation source 101, but operates independently of the primary radiation source 101. The second radiation source 146 creates one of: low-energy d-D neutrons, d-T neutrons, or any other suitable type of neutrons. Advantageously, use of d-D neutrons, in combination with positioning of the cargo 151 to obtain the optimal active inspection signals 160, permits measurements of delayed radiation and differential die-away. This increases the accuracy of detecting a nuclear material within the cargo 151, and minimizes false alarms.

After the neutrons emitted either by the photon-to-conversion material 170 or by the secondary radiation source 146 impinge the cargo 151, the detectors 120, 121 output signals 160 that represent delayed radiation (e.g. prompt and delayed neutrons and gamma rays) measurements and/or differential die away measurements. These signals are processed by the microprocessor 128 to confirm or clear a suspected presence of nuclear materials in the cargo 151.

In one embodiment, the cargo 151 is moved to a position 125 that is calculated by the microprocessor 128 to produce optimal active inspection signals 160. Alternatively or additionally, the primary radiation source 101 and/or the secondary radiation source 146 are moved relative to the cargo 151 to the position 125 calculated by the microprocessor 128 to produce the optimal active inspection signals 160. In the same or a different embodiment, the detectors 120,121 are moved relative to the cargo 151 to detector positions (shown in FIG. 2) calculated by the microprocessor 128 to produce the optimal active inspection signals 160. The optimal active inspection signals 160 is an analog or digital signal, representing measurements of delayed radiation and/or measurements of differential die-away, which is more accurate than if a similar analog or digital signal were obtained without moving (a) the cargo 151, (b) the primary radiation source 101, or (c) a secondary radiation source 146.

Various means are used to achieve the position 125 of the cargo 151 calculated by the microprocessor 128 to produce the optimal active inspection signals 160. In one embodiment, the cargo 151 rests on a platform 110. The platform 110 is supported by a frame 109, which can be raised or lowered along a vertical axis 123, in response to control signals 180 outputted by the microprocessor 128. The microprocessor 128 receives radiographic or tomographic image data 190 from the detector 105. Using one or more predetermined algorithms 137, 138 stored in a computer readable memory 130, the microprocessor 128 processes the radiographic or tomographic image data 190 to determine the multi-dimensional coordinates of the suspect object(s) 104, if any. In one embodiment, the algorithms 137 are location-determining algorithms; and the algorithms 138 are spectral-analysis and/or image processing algorithms. Additional algorithms 193, 194 are also stored in the computer-readable memory 130. In one embodiment, the algorithms 193 are detection algorithms, which the microprocessor 128 executes to process the optimal active inspection signals 160. In one embodiment, the algorithms 194 are rescanning algorithms, which the microprocessor 128 executes if the processed optimal active inspection signals 160 yield results that are inconclusive (e.g., the suspected presence of nuclear materials in the cargo 151 cannot be cleared or confirmed).

Using pre-determined cargo information and/or pre-determined scanner information inputted by the input device 131 (or preloaded in the computer-readable memory 130), the microprocessor 128 calculates how best to position the cargo 151 (and/or the primary radiation source 101, the secondary radiation source 146, the detector 105, and the detectors 120, 121) to obtain the optimal active inspection signals 160 from the detectors 120, 121. The pre-determined cargo information includes, but is not limited to, the cargo's dimensions, volume, density, position of the cargo in multi-dimensional space, etc. The pre-determined scanner information includes, but is not limited to, the energy and type of active inspection to be performed (e.g., photofission or particle fission), positions of the detectors 120, 121 relative to the cargo 151, positions of the actuators 139 that move the ray detectors 120, 121, position of the platform 110 within multi-dimensional space, position of actuator(s) 135 that move the platform 110 and/or the frame 109, and so forth. Once these calculations are complete, the microprocessor 128 outputs one or more control signals 180.

The cargo characteristics (density and elemental composition) briefly mentioned above have a strong influence on: (a) the attenuation of the interrogating radiation towards the location of the suspect object 104, (b) the radiation attenuation towards the detectors, and (c) neutron thermalization. The latter is important for the differential-die-away technique, and because thermalization affects the fission rates.

Additionally, low-energy d-D based fission produces fewer delayed neutrons than the number of prompt neutrons. Therefore, for organic cargoes inspected using d-D based fission, the strongest signals would be delayed gamma rays and differential-die-away neutrons. While for pure inorganic cargos inspected using d-D based fission, the main signals would be delayed neutrons and gamma rays. There would be some cases where no signals would be obtained for some positions in the cargo 151. Accordingly, the microprocessor 128 is configured to output signals 191 indicating whether the cargo inspection system 100 can confirm/clear the presence of nuclear material at the location of the suspect object 104.

The low-energy d-D neutrons are more penetrating than the delayed neutrons produced after fission occurs, but are less penetrating than the prompt neutrons produced after fission occurs. Therefore, for organic cargos, the active inspection signals 160 (e.g., prompt-neutron signals and/or delayed gamma-ray signals) produced by the detectors 120, 121 are optimized when the suspect object(s) 104 is/are closer to the primary radiation source 101, or to the secondary radiation source 146.

On the other hand, in an embodiment of the cargo inspection system 100 that uses d-T neutrons, the impinging d-T neutrons are more penetrating than the delayed and prompt neutrons produced after fission occurs. Accordingly, the active inspection signals 160 produced by the detectors 120, 121 are optimized when the suspect object 104 is closer to the detectors 120, 121. Similarly, for detecting the delayed neutrons, the suspect object 104 should be closer to the detectors 120, 121. For relatively homogeneously distributed cargoes, the signal on reflection and top/bottom detectors 120,121 is optimized when the suspect object 104 is closer to the primary radiation source 101, or to the secondary radiation source 146. In one embodiment, for cargo 151 configured in a heterogeneous way, the processor 128 is configured to determine the optimal position of a suspect object 104 based on the suspect object's actual configuration and/or location within the cargo 151, using a multi-dimensional density map provided by a prior high-resolution tomographic scan.

Referring still to FIGS. 1, 2, and 3, in one embodiment, the microprocessor's outputted control signals 180 rotate the platform 110, and/or raise or lower the frame 109, until the cargo 151 is in the position 125 calculated by the microprocessor 128 to produce the optimal active inspection signals 160. In another embodiment, in which the cargo 151 remains stationary, one or more of the primary radiation source 101, the detector 105, the secondary radiation source 146, and/or the detectors 120, 121 move in response to the outputted control signals 180 to a position calculated by the microprocessor 128 to produce the optimal active inspection signals 160. Thereafter, the cargo 151 is actively inspected, as explained below. For example, a timing module 132 that links the computer processor 128 with the radiation source 101 operates the primary radiation source 101 (and/or the secondary radiation source 146), in a continuous or a pulsed fashion, based on control signals 180 outputted by the microprocessor 128. The microprocessor 128 processes the active inspection signals 160 and outputs data 191 confirming or clearing a suspected presence of a nuclear material (and/or a conventional explosive) within the cargo 151. The outputted data 151 may be displayed on a display device 129 and/or used to activate an alarm 192. The cargo 151 is cleared if no explosives are detected, and/or if no nuclear materials are present.

In one embodiment, one or more of the detectors 120,121 are moved closer to the suspect object 104 to obtain the optimal active inspection signals 160. As used herein, the term “microprocessor” or “processor” broadly refers to a computer, a microcontroller, a microcomputer, a programmable logic controller, an application specific integrated circuit, or to any other type of programmable circuit.

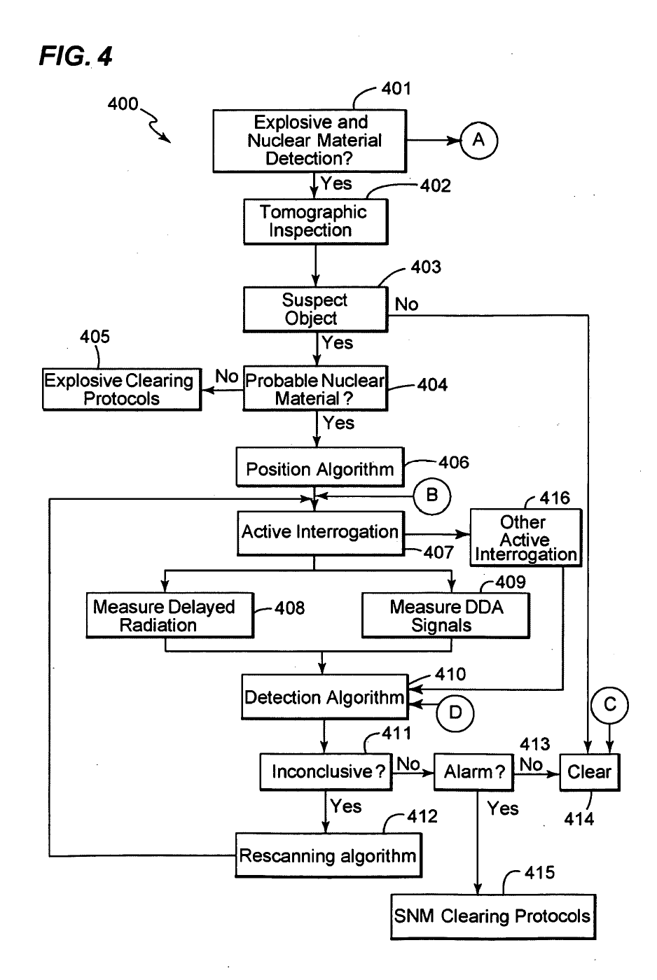

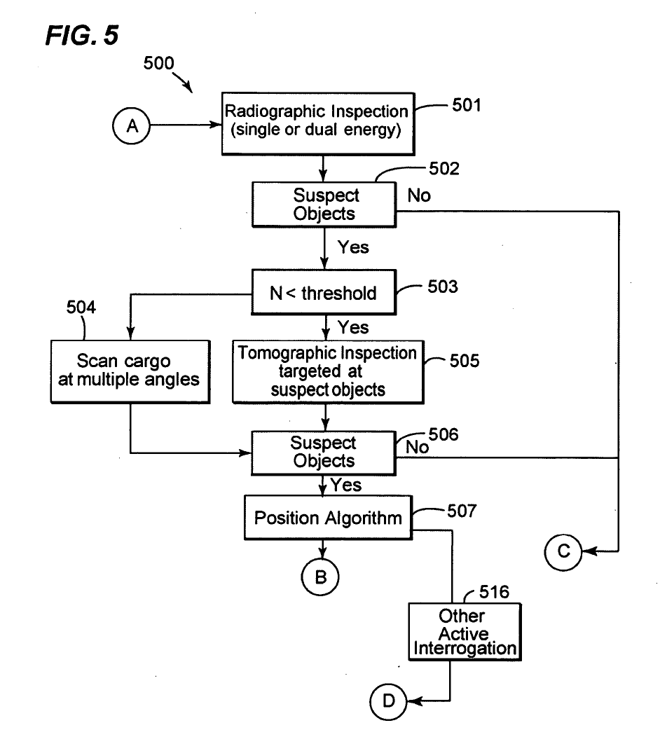

FIGS. 4 and 5 are block diagrams of embodiments of computer-implemented cargo inspection methods. Each block, or combination of blocks, depicted in each of the block diagrams can be embodied in computer program instructions. These computer program instructions may be loaded onto, or otherwise executable by, a microprocessor 128, or other programmable apparatus, to produce a machine, such that the instructions, which execute on the microprocessor 128, or other programmable apparatus, create means or devices for implementing the functions specified in blocks of the block diagrams. These computer program instructions are stored in the computer-readable memory 130. Unless otherwise noted, the functions represented by each of the blocks of each block diagram can be performed in any suitable order or combination.

Referring to FIGS. 1, 2, 3, and 4, a method 400 for operating an embodiment of the cargo inspection system of FIGS. 1, 2, and 3, includes the functions represented by the blocks 401, 402, 403, 404, 405, 506, 407, 408, 409, 410, 411, 412, 413, 414, and 415. The method 400 is implemented when explosive and nuclear materials are to be detected simultaneously, or near simultaneously.

As represented by the decision block 401, the method 400 begins by determining whether a simultaneous inspection for explosives and/or nuclear materials is to be performed. If no, meaning that detection of nuclear materials only is required, the method 500 of FIG. 5 is executed. If yes, the method 400 further includes, as represented by the block 402, performing a tomographic scan of the cargo 151 with parameters suited for detection of explosives and nuclear materials, using the primary radiation source 101 of the cargo inspection system 100. After the tomographic scan is performed, the method 400 further includes, as represented by the decision block 403, determining whether one or more suspect objects 104 are concealed within the cargo 151. If no suspect objects 104 are present, the method 400 further includes, as represented by the block 414, clearing the cargo 151 from further inspection. If one or more suspect objects 104 are present, the method 400 further includes, as represented by the decision block 404, determining whether any of the one or more suspect objects 104 have at least a predetermined threshold probability of containing one or more nuclear materials. The method 400 further includes, as represented by the block 405, performing pre-determined explosive clearing protocols. As mentioned previously, the functions of blocks 404 and 405 can be performed simultaneously, or near simultaneously.

If at least one of the suspect objects 104 has a predetermined probability of containing a nuclear material, the method 400 further includes, as represented by the block 406, calculating a position that optimizes active inspection signals 160 outputted by one or more detectors 120, 121, which were previously described. In one embodiment, this position is the position 125 of the cargo 151. In another embodiment, this position is a position of one or more of the primary radiation source 101, the detector(s) 105, the detectors 120, 121, and/or the photon-to-neutron conversion material 170. Referring to FIG. 3, the microprocessor 128 calculates this position using one or more position algorithms 138 stored in the computer-readable memory 130, as previously described.

The method 400 further includes, as represented by the block 407, performing an active inspection. As described above, the method 400 further includes, as represented by the block 408, measuring delayed radiation and/or, as represented by the block 409, measuring Differential Die Away (“DDA”) signals. Of course other active inspection techniques may also be used.

The method 400 further includes, as represented by the block 410, processing the optimal active inspection signals 160 and outputs a signal 191 indicative of whether a nuclear material is present or not. The microprocessor 128 (FIG. 3) processes the optimal active inspection signals 160 using one or more analysis algorithms 137 stored in the memory device 130.

Referring again to FIG. 4, the method 400 further includes, as represented by the decision block 411, determining whether the results of the active inspection are inconclusive. If yes, the method 400 further includes executing a re-scanning algorithm 194, represented by block 412, to modify the scanning parameters of the active inspection and loop back to perform again the functions represented by the blocks 407, 708, 409, 410, and 411. The rescanning algorithm 194 could include one or combination of the following: longer inspection time for one or more of the active inspection methods, different pulsing structure for performing the differential-die-away inspection, different on/off times for performing the delayed radiation measurements, detector repositioning, and so forth. Referring again to the block 411, if the detection results are conclusive (e.g., a nuclear material might have possibly been detected), the method 400 further includes, as represented by decision block 413, determining whether to activate an alarm. In one embodiment, an operator can analyze the tomographic images and the additional information obtained with the active inspection methods to confirm or to clear the alarm. If the operator confirms the presence of a nuclear material, the function of block 413 further includes activating the alarm. Additionally, the method 400 further includes, as represented by the block 415, routing the cargo container for a nuclear material clearing protocol that could include a manual search. Otherwise, referring again to the decision block 413, the microprocessor 128 or operator, as represented by the block 414, clears the cargo 151 of any presence of nuclear material, and of the need for further inspection.

Referring now to FIGS. 1, 2, 3, 4, and 5, a method 500 of operating an embodiment of a cargo inspection system 100 of FIGS. 1, 2, and 3, is implemented when explosives and nuclear materials are not to be detected simultaneously. The method 500 includes the functions represented by the blocks 501, 502, 503, 504, 505, 506, and 507, as well as the functions described above of blocks 407, 408, 409, 410, 411, 412, 413, 414, and 415 of FIG. 4.

Accordingly, the method 500 may begin, as represented by the block 501, by performing either a single energy or a dual energy radiographic scan of the cargo 151 using the primary radiation source 101 of the cargo inspection system 100.

After the radiographic scan is performed, the method 500 further includes, as represented by the decision block 502, determining whether one or more suspect objects 104 are concealed within the cargo 151. If no suspect objects 104 are present, the method 500 further includes, as represented by the block 414, clearing the cargo 151 from further inspection. On the other hand, if N suspect object(s) is/are present (where N is an integer 1, 2, 3, 4 . . . ), the method 500 further includes, as represented by the decision block 504, determining whether N is less than a pre-determined threshold. In one embodiment, the pre-determined threshold is N=5. Referring again to the block 503, if N is greater than the predetermined threshold, meaning that a large number of suspect objects 104 are present—or if a suspect area is large—, the method 500 further includes, as represented by the block 504, scanning all, or part of, the cargo 151 at multiple angles and estimating an approximate depth of the suspect objects 104. The function represented by the block 504 further includes clearing some of the suspect objects 104 based on additional information obtained from scanning all, or part, of the cargo 151 at multiple angles. These functions are significantly faster than performing a tomographic scan. However, N could be setup to be zero to perform tomographic measurements of all alarming objects.

Referring again to the decision block 503, if N is less than the pre-determined threshold (meaning that a small number of suspect objects is present), or if N is set to 0, the method 500 further includes, as represented by the block 505, performing a tomographic scan targeted at one or more of the suspect objects 104 with scan parameters tailored for detection of nuclear materials.

Following performance of the functions represented by the blocks 504 and 505, the method 500 further includes, as represented by the decision block 506, determining whether any of suspect objects 104 have at least a predetermined threshold probability of containing nuclear materials. If not, the method 500 further includes, as represented by the block 414, clearing the cargo 151 from further inspection. If one or more suspect objects 104 have the predetermined threshold probability of containing nuclear materials, the method 500 further includes, as represented by the block 507, calculating a position (previously described) that produces optimal active inspection signals 160 in the one or more detectors 120, 121 (also previously described). Referring to FIG. 3, the microprocessor 128 calculates this position using one or more position algorithms 128 stored in the memory device 130, as previously described.

Thereafter, the method 500 further includes performing the functions represented by the blocks 407, 408, 409, 410, 411, 412, 413, 414, and 415 of FIG. 4, which were previously described above.

### Alternative Embodiments

Referring to FIG. 1, depending on the embodiment, the primary radiation source 101 may be one of: a gamma-ray generator, a linear accelerator producing gamma rays from specific nuclear reactions, or other neutron or high-energy photon generator.

This written description uses examples to disclose the invention, including the best mode, and also to enable any person skilled in the art to make and use embodiments of the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the scope of the following claims.

What is claimed is:

1. A cargo inspection system, comprising:
one or more radiation detectors;
a primary radiation source configured to emit a beam of radiation that impinges a cargo; and
a microprocessor configured to calculate a position of the cargo that produces optimal active inspection signals in the one or more detectors if fission occurs within the cargo.

2. The cargo inspection system of claim 1, wherein the one or more detectors are configured to detect prompt neutrons and delayed neutrons, and wherein the one or more detectors are configured to detect delayed gamma-rays.

3. The cargo inspection system of claim 1, wherein each of the one or more detectors is configured to detect prompt neutrons, delayed neutrons, and delayed gamma-rays.

4. The cargo inspection system of claim 1, further comprising:
a platform configured to support the cargo, wherein the platform is movable along a vertical axis of the cargo and/or is rotatable; and
an actuator coupled with the platform and the microprocessor.

5. The cargo inspection system of claim 1, wherein the beam of radiation comprises high-energy photons.

6. The cargo inspection system of claim 5, further comprising:
a photon-to-neutron conversion material positioned between the primary radiation source and the cargo, wherein the photon-to-neutron conversion material converts some of the high-energy photons and emits neutrons that impinge the cargo.

7. The cargo inspection system of claim 5, further comprising:
a secondary radiation source, wherein the secondary radiation source is configured to emit neutrons.

8. The cargo inspection system of claim 8, wherein the neutrons are one of d-D neutrons, d-T neutrons, and p-Li neutrons.

9. The cargo inspection system of claim 1, wherein the cargo is air cargo.

10. A method for confirming or clearing a suspected presence of nuclear materials in a cargo, the method comprising:
performing a tomographic scan of the cargo with parameters suited for detection of explosives and nuclear materials, using a primary radiation source of a cargo inspection system;
determining whether one or more suspect objects are concealed within the cargo;
if no suspect objects are present, clearing the cargo from further inspection;
if one or more suspect objects are present, determining whether any of the one or more suspect objects have at least a predetermined threshold probability of containing one or more nuclear materials;
performing pre-determined explosive clearing protocols; and
if at least one of the suspect objects has a predetermined probability of containing a nuclear material, calculating a position that optimizes active inspection signals outputted by one or more detectors.

11. The method of claim 10, wherein the function of determining whether any of the one or more suspect objects have at least a predetermined threshold probability of containing one or more nuclear materials and the function of performing pre-determined explosive clearing protocols are performed simultaneously.

12. The method of claim 10, wherein the position that optimizes active inspection signals is a position of the cargo.

13. The method of claim 10, further comprising:
performing an active inspection of the cargo;
measuring delayed radiation; and/or,
measuring Differential Die Away (“DDA”) signals.

14. The method 400 of claim 13, further comprising:
processing the optimal active inspection signals and outputting a signal indicative of whether a nuclear material is present or not.

15. The method of claim 14, further comprising:
determining whether the results of the active inspection are inconclusive; and
if yes, executing a re-scanning algorithm to modify scanning parameters of the active inspection and to loop back to perform again the functions of claim 13.

16. The method of claim 10, wherein the cargo is air cargo.

17. A method for confirming or clearing a suspected presence of a nuclear material in a cargo, the method comprising:
performing either a single energy or a dual energy radiographic scan of the cargo using a primary radiation source of a cargo inspection system;
determining whether one or more suspect objects are concealed within the cargo;
if no suspect objects are present, clearing the cargo from further inspection.
if N suspect object(s) is/are present (where N is an integer 1, 2, 3, 4 . . . ), determining whether N is less than a pre-determined threshold;
if N is greater than the predetermined threshold, scanning all, or part of, the cargo at multiple angles and estimating an approximate depth of the suspect objects.

18. The method of claim 17, wherein the pre-determined threshold is N=5 or N=0.

19. The method of claim 17, wherein the function further includes:
clearing some of the suspect objects based on additional information obtained from scanning all, or part, of the cargo at multiple angles.

20. The method of claim 17, further comprising:
if N is less than the pre-determined threshold, or if N is set to 0, performing a tomographic scan targeted at one or more of the suspect objects with scan parameters tailored for detection of nuclear materials;
determining whether any of suspect objects have at least a predetermined threshold probability of containing nuclear materials;
if not, clearing the cargo from further inspection; and
if one or more suspect objects have the predetermined threshold probability of containing nuclear materials, calculating a position that produces optimal active inspection signals in one or more detectors.

21. The method of claim 20, wherein the position is a position of the cargo.

22. The method of claim 20, wherein the cargo is air cargo.
